(19) United States
(12) Patent Application Publication
(10) Pub. No.: US 2023/0219196 A1
(43) Pub. Date: Jul. 13, 2023

(54) RATCHET WOODWORKING CLAMP WITH UNIVERSAL ADAPTIVE CLAMPING BLOCK

(71) Applicant: Shanghai NEOCRAFT Tool Co., Ltd., Shanghai (CN)

(72) Inventor: Hongwen ZHU, Shanghai (CN)

(21) Appl. No.: 18/186,998

(22) Filed: Mar. 21, 2023

Related U.S. Application Data
(63) Continuation-in-part of application No. 17/447,269, filed on Sep. 9, 2021.

(30) Foreign Application Priority Data
Jul. 12, 2021 (CN) 202121572702.9

(51) Int. Cl. B25B 5/06; B25B 5/16; B25B 5/02

(52) U.S. Cl. CPC B25B 5/068; B25B 5/163; B25B 5/166; B25B 5/02

(57) ABSTRACT

A ratchet woodworking clamp with a universal adaptive clamping block includes a fixed clamp arm and a movable clamp arm, the fixed clamp arm and the movable clamp arm being both provided with an arc-shaped notch, and the arc-shaped notch being matched and connected with a movable connecting member, wherein a middle portion of the arc-shaped notch is provided with a semi-spherical or spherical groove recessed inwardly, one side of the movable connecting member is a circular connecting end, which is in matched connection with the arc-shaped notch, and the circular connecting end is provided with a spherical or semi-spherical convex structure in an inward direction, which is matched and connected with the groove in the middle portion of the arc-shaped notch.

### CROSS REFERENCES

This application is a continuation in part application of U.S. Ser. No. 17/447,269 that claims priority to Chinese Patent Application Ser. No. 202121572702.9 filed 12 Jul. 2021.

### TECHNICAL FIELD

The utility model relates to the field of woodworking clamp technologies, and more particularly, to a ratchet woodworking clamp with a universal adaptive clamping block.

### BACKGROUND ART

A woodworking clamp is a commonly used clamping tool in carpentry. A common woodworking clamp aims to clamp a flat surface of a wooden plate in designing, and at the moment, a clamp mouth may clamp a wooden block well, which is not easy to slide. For example, according to a ratchet woodworking clamp with an universal adaptive clamp jaw provided by Chinese patent CN202021626139.4, the clamp mouth can automatically adapt to an inclination angle of the wooden plate to increase a clamping effect of the woodworking clamp. However, in an actual production operation, the woodworking clamp cannot be ensured to be certainly clamped on a surface of a flat wooden plate or a wooden plate with a certain inclination angle. Moreover, the inclination angle of the wooden plate that the above patent can adapt to is limited to a certain extent. Therefore, in the actual production operation, when dealing with a wooden plate with a large inclination angle or a special-shaped wooden plate, an angled gap between the wooden plate and the clamp jaw of the woodworking clamp occurs, which makes the woodworking clamp unable to firmly and evenly clamp the wooden plate, and causes an insufficient clamping force. At the moment, in order to clamp firmly, over clamping force may be applied, which causes damage to the surface of the wooden plate or making the wooden plate slip out of the woodworking clamp.

### SUMMARY OF THE INVENTION

The utility model aims to solve the defects in problem, and provides a ratchet woodworking clamp with an universal adaptive clamp jaw being capable of rotating in any direction for matching the inclined surface automatically for creating perfect clamping contact.

In order to achieve the above objective, a ratchet woodworking clamp with a universal adaptive clamp jaw is designed, which includes: a fixed clamp arm (1) and a movable clamp arm (4), the fixed clamp arm (1) and the movable clamp arm (4) are both provided with an arc-shaped notch (2), and the arc-shaped notch (2) is matched and connected with a movable clamp jaw (3), wherein a middle portion of the arc-shaped notch (2) is provided with a semi-spherical or spherical groove recessed inwardly, one side of the movable clamp jaw (3) is a circular connecting end, which is matched and connected with the arc-shaped notch (2), and the circular connecting end is provided with a spherical or semi-spherical convex structure in an inward direction, which is matched and connected with the groove in the middle portion of the arc-shaped notch (2). An arc-shaped notch (12) is set on the fixed clamp arm (1), and an inwardly recessed spherical groove (13) is provided in the middle of the arc-shaped notch (12). A caliper (14) includes a circular connecting end (15), and the middle part of the connecting end (15) is provided with a spherical protrusion (16). After assembly, the spherical protrusion (16) cooperates with the spherical groove (13). Freed from axial constraints during movement, the spherical projection and spherical groove can move in a 360° direction, and there is a certain degree of freedom between the connecting end (15) of the caliper (14) and the arc-shaped notch (12), so the caliper (14) can be adjusted universally.

The utility model further has the following preferred technical solution.

Further, a certain gap exists between the movable clamp jaw (3) and a periphery of the arc-shaped notch (2) to ensure a rotation angle of the movable clamp jaw.

Further, a clamp jaw pad (5) is mounted on the other side of the movable clamp jaw (3).

Further, a lower portion of the clamp jaw pad is provided with an extension portion matched with the fixed clamp arm (1) and the movable clamp arm (4).

Further, a surface of the clamp jaw pad is provided with an anti-skid structure.

Further, side surfaces of the fixed clamp arm (1) and the movable clamp arm (4) are provided with a reinforcing rib.

The utility model has the following beneficial effects.

The ratchet woodworking clamp with the universal adaptive clamp jaw provided by the utility model is simple in structure and strong in practicability, the semi-spherical or spherical groove in the arc-shaped notch is connected with the circular connecting end on one side of the movable clamp jaw to make the movable clamp jaw rotates in any needed direction, so that the movable clamp jaw may adapt to different angled clamping surfaces, the clamp jaw is unlimited by an angle range of a working member and rotates freely, and the clamp jaw pad is attached to the surface of a wooden plate, thus obtaining a best clamping working effect and protect the object from been damaged.

### BRIEF DESCRIPTION OF THE DRAWINGS

FIG. 1 illustratively shows a schematic diagram of a structure of the utility model;

FIG. 2 illustratively shows a schematic diagram of assembly of a movable clamp jaw and a fixed clamp arm of the utility model;

FIG. 3 illustratively shows a top view of the movable clamp jaw and the fixed clamp arm of the utility model;

FIG. 4 shows an explosion diagram of the fixed clamp arm of the utility model; and

FIG. 5 shows a partial diagram of the fixed clamp arm of the utility model.

Wherein: 1 refers to a fixed clamp arm, 2 refers to an arc-shaped notch, 3 refers to a movable clamp jaw, 4 refers to a movable clamp arm, 5 refers to a clamp jaw pad, 201 refers to a semi-spherical groove, and 301 refers to a semi-spherical convex structure, 12 refers to an arc-shaped notch; 13 refers to an inwardly recessed spherical groove, 14 refers to a caliper, 15 refers to a circular connecting end, and 16 refers to a spherical protrusion.

### DETAILED DESCRIPTION OF THE PREFERRED EMBODIMENTS

The preferred embodiments of the utility model are described hereinafter with reference to the accompanying drawings. It should be understood that the preferred embodiments described herein are only used for describing and explaining the utility model and are not intended to limit the utility model.

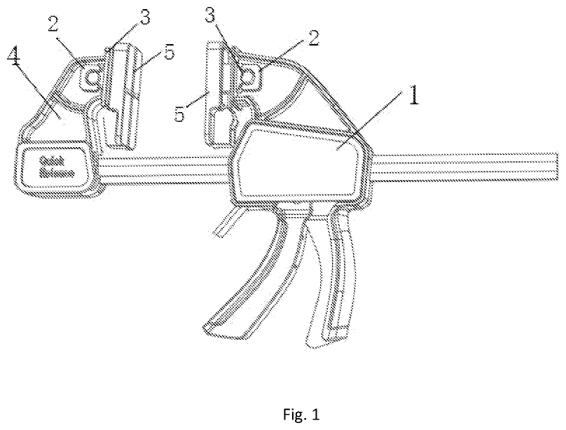

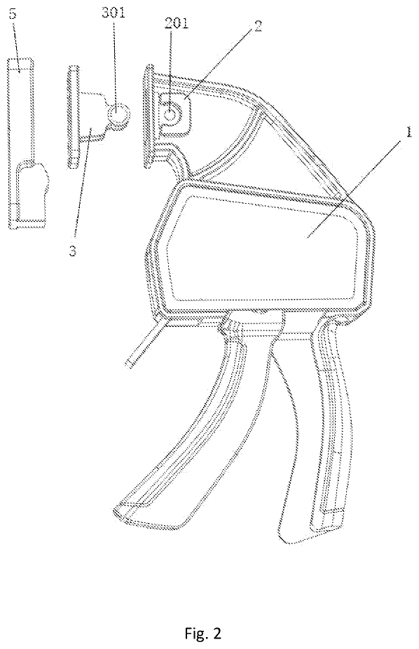

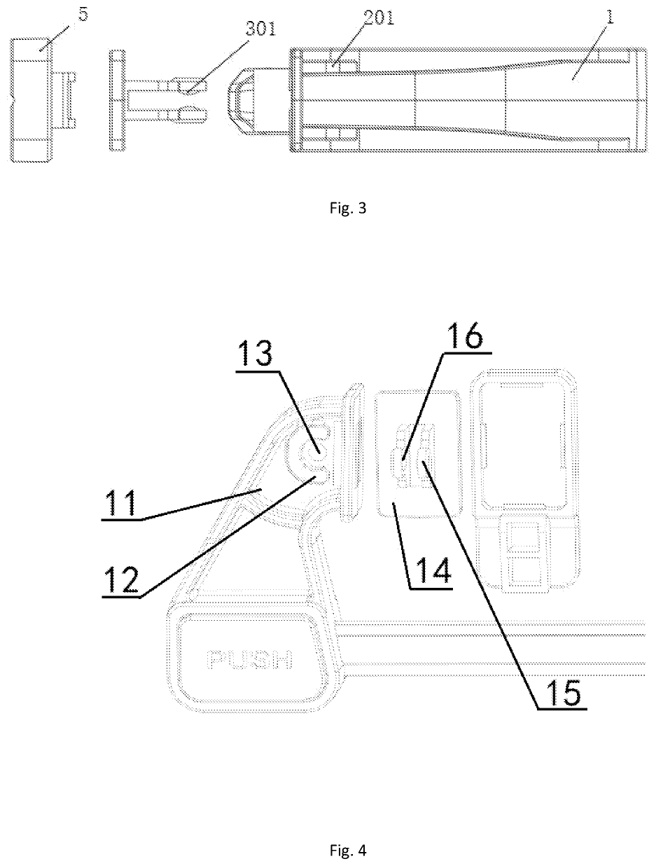

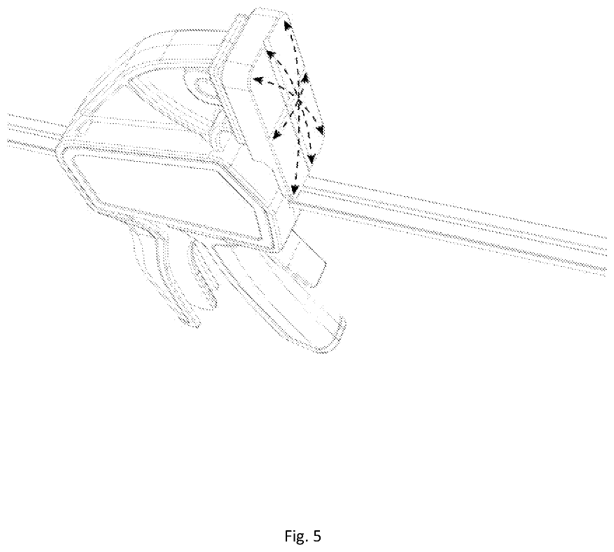

Embodiment 1 of the utility model is shown in FIG. 1, and provides a woodworking clamp with a clamp jaw 3 capable of freely rotating around a fixed end to adapt to a surface of a wooden plate, which includes a fixed clamp arm 1 and a movable clamp arm 4. The fixed clamp arm 1 and the movable clamp arm 4 are both provided with an arc-shaped notch 2, the arc-shaped notch 2 is connected with a clamp jaw pad 5 through a movable clamp jaw 3, and the arc-shaped notch 2 on the fixed clamp arm 1 is shown in FIG. 2. A middle portion of the fixed clamp arm 1 is provided with an inwardly recessed semi-spherical groove 201, and the movable clamp jaw 3 is provided with a semi-spherical convex structure 301 corresponding to the semi-spherical groove 201 to be matched with the semi-spherical groove 201, so that the movable clamp jaw 3 may rotate freely around the matching position. A certain gap exists between a periphery of the arc-shaped notch 2 and the movable clamp jaw 3, so that the movable clamp jaw 3 may drive the clamp jaw pad 5 to rotate in any direction for getting best contact to the object surface without being limited an shaft or axle. As shown in FIG. 3, the clamp jaw pad 5 is mounted on the movable clamp jaw 3 through a convex structure, the clamp jaw pad 5 and the fixed clamp arm 1 are mutually independent parts, and a certain gap is formed between the clamp jaw pad 5 and the fixed clamp arm 1 through the movable clamp jaw 3, which is convenient for the clamp jaw pad 5 to move in all directions. A lower portion of the clamp jaw pad 5 is provided with a limiting portion, and the fixed clamp arm 1 is provided with a recess on a position corresponding to the inwardly recessed semi-spherical groove 201, so that when the clamp jaw pad 5 moves downwardly, a sufficient space exists between the fixed clamp arm 1 and the clamp jaw pad 5 for the clamp jaw pad 5 to move.

An arc-shaped notch (12) is set on the fixed clamp arm (1), and an inwardly recessed spherical groove (13) is provided in the middle of the arc-shaped notch (12). A caliper (14) includes a circular connecting end (15), and the middle part of the connecting end (15) is provided with a spherical protrusion (16). After assembly, the spherical protrusion (16) cooperates with the spherical groove (13). Freed from axial constraints during movement, the spherical projection and spherical groove can move in a 360° direction, and there is a certain degree of freedom between the connecting end (15) of the caliper (14) and the arc-shaped notch (12), so the caliper (14) can be adjusted universally.

### Embodiment 2

In addition, in order to make the utility model clamp a wooden plate better, the embodiment further includes the following structure: one side of the movable clamp arm is provided with a driving metal plate, one side of the driving metal plate is provided with a spring A, one side of the spring A is provided with a straight sliding rod, one end of the straight sliding rod is provided with a fixing hole, and one side of the fixing hole is provided with a fixing member. The other side of the spring A is provided with a semi-circular arc supporting point, and a bottom end of the semi-circular arc supporting point is provided with a force application driving rod. The other side of the semi-circular arc supporting point is provided with a spring B, and one side of the spring B is provided with a positioning clamp release metal plate. The other side of the movable clamp arm is provided with a quick release button, a bottom portion of the spring A is provided with a spring C, and one side of the spring C is provided with a positioning bolt of the force application driving rod. Side surfaces of the fixed clamp arm and the movable clamp arm are both provided with a reinforcing rib, and the reinforcing ribs are distributed in an arc shape. Cross sections of the fixed clamp arm and the movable clamp arm both include an I-shaped structure. A surface of the clamping block is provided with an anti-skid structure.

In a use process, the positioning clamp release metal plate is formed by combining two metal plates, and plays a role of positioning and clamping after clamping. By arranging the straight sliding rod and the force application driving rod, the movable clamp arm on the straight sliding rod is pushed forward by the force application driving rod, and at the moment, a workpiece is placed in the middle of the clamping block. The workpiece is clamped by actions of the fixed clamp arm and the movable clamp arm, and at the moment, the clamp jaw pad may automatically rotate around the matching position between the semi-spherical convex structure 301 and the semi-spherical groove 201 according to a surface of the clamped workpiece, so that the clamping block may be tightly attached to the surface of the workpiece, and a structural strength of the clamp is greatly improved by actions of the spring and the driving metal plate. The driving metal plate may accelerate pushing and improve a clamping force of the clamp, and the movable clamp arm may be removed from the straight sliding rod at any time by an action of the positioning clamp release metal plate, which is convenient for disassembly. Moreover, the driving metal plate is elastically pushed to balance an accelerated pushing force in a process of applying a force by an action of the spring, and the driving metal plate is elastically pushed after clamping, so that the force application driving rod is restored to an original position. Moreover, the movable clamp arm may move to the other side of the fixed clamp arm on the straight sliding rod to play a role of opening and applying a force, and the quick release button may be used to move the movable clamp arm back and forth on the straight sliding rod.

The foregoing is only the specific implementations of the utility model, but the scope of protection of the utility model is not limited to this. Equivalent substitutions or changes made by those skilled in the art according to the technical solutions and novel concepts of the utility model within the technical scope disclosed in the utility model should be included in the scope of protection of the utility model.

1. A ratchet woodworking clamp with two universal adaptive clamp jaws, comprising
a fixed clamp arm and a movable clamp arm,
the fixed clamp arm and the movable clamp arm being both provided with an arc-shaped notch, and the arc-shaped notch being matched and connected with a movable clamp jaw, wherein,
a middle portion of the arc-shaped notch is provided with a semi-spherical or spherical groove recessed inwardly,
one side of the movable clamp jaw is a circular connecting end, which is matched and connected with the arc-shaped notch, and the circular connecting end is provided with a spherical or semi-spherical convex structure, which is matched and connected with the groove in the middle portion of the arc-shaped notch;
a clamp jaw pad is mounted on the other side of the movable clamp jaw; and
the movable clamp jaw is capable of moving together with the clamp jaw pad in any directions on universal planes including horizontal, vertical and all kind of oblique directions.

2. The ratchet woodworking clamp with the two universal adaptive clamp jaws according to claim 1, wherein a gap exists between the movable clamp jaw and a periphery of the arc-shaped notch.

3. The ratchet woodworking clamp with the two universal adaptive clamp jaws according to claim 1, wherein a bottom portion of the clamp jaw pad moves along the fixed clamp arm and the movable clamp arm.

4. The ratchet woodworking clamp with the two universal adaptive jaw according to claim 3, wherein a surface of the clamp jaw pad is provided with an anti-skid structure.

5. The ratchet woodworking clamp with the two universal adaptive clamp jaws according to claim 1, wherein side surfaces of the fixed clamp arm and the movable clamp arm are provided with a reinforcing rib, and the reinforcing ribs are distributed in an arc shape.

6. The ratchet woodworking clamp with the two universal adaptive clamp jaws according to claim 1, wherein the fixed clamp arm is installed an arc-shaped notch, and an inwardly recessed spherical groove is provided in the middle of the arc-shaped notch; a caliper includes a circular connecting end, and the middle part of the connecting end is provided with a spherical protrusion; after assembly, the spherical protrusion cooperates with the spherical groove, freed from axial constraints during movement, the spherical projection and spherical groove is capable to move in a 360° direction, and there is a certain degree of freedom between the connecting end of the caliper and the arc-shaped notch, the caliper groove is capable to be adjusted universally.
